(19) United States
(12) Patent Application Publication
(10) Pub. No.: US 2020/0132425 A1
(43) Pub. Date: Apr. 30, 2020

(54) BLASTING METHOD

(71) Applicant: OPTIMUCK, LLC, Cedar Creek, TX (US)

(72) Inventor: Jay H. HECK, Sr., Cedar Creek, TX (US)

(73) Assignee: OPTIMUCK, LLC, Cedar Creek, TX (US)

(21) Appl. No.: 16/607,003

(22) PCT Filed: Apr. 24, 2018
(86) PCT No.: PCT/US2018/029046

§ 371 Date: Oct. 21, 2019

Related U.S. Application Data
(60) Provisional application No. 62/489,854, filed on Apr. 25, 2017.

(51) Int. Cl. F42D 3/04; F42D 1/10

(52) U.S. Cl. CPC F42D 3/04; G01V 9/00; F42D 1/10

(57) ABSTRACT

Methods for using a single explosive material whose specific volume energy can be controlled for use in at least a segment of a borehole. Alternatively, or additionally, methods for using mixtures of one or more explosive materials and one or more non-explosive energetic materials whose specific volume energy can be controlled for use in at least a segment of a borehole. Such methods include determining a target specific volume energy required for the explosive/energetic materials in the segment of the borehole and selecting a product mixture for that segment of the borehole which will produce the required target energy.

### CROSS-REFERENCE TO RELATED APPLICATIONS

This application claims the benefit of U.S. Provisional Application Ser. No. 62/489,854 filed Apr. 25, 2017 titled “Blasting Method.” The provisional application is incorporated by reference herein as if reproduced in full below.

### FIELD

Methods for evaluating drill pattern parameters such as burden, spacing, borehole diameter, etc., at a blast site and implementing same when taking into account the proper balance of materials and/or output energies to the associated rock burden.

### BACKGROUND

In modern bench blasting, vertical or near vertical holes are drilled adjacent to a rock face and are loaded with explosive charges that are then detonated. The detonation fractures the rock mass between the borehole and the rock face and displaces the resulting fractured rock. The resulting broken rock, known as “muck”, is removed and a new free rock face is thus exposed. If the muck contains a desired product, it can be gathered and processed. Otherwise, it may simply be removed from the blasting site to permit further blasting or other activities.

U.S. Pat. No. 8,538,698, titled “Blasting Method,” issued Sep. 17, 2013, to Jay Howard Heck, Sr. (the “Heck '698 Patent ”) discloses methods for evaluating drill pattern parameters such as burden, spacing, borehole diameter, etc., at a blast site. One method disclosed in the Heck '698 Patent involves accumulating the burden contributed by successive layers of rock and matching the accumulated rock burden to a target value for a borehole having a length related to the average height of the layers. Another method disclosed in the Heck '698 Patent relates to varying drill pattern parameters and characteristics to match blast design constraints, including the substitution of one explosive material for another by the proper balance of materials and/or output energies to the associated rock burden. The Heck '698 Patent further discloses that the various methods can be practiced using an appropriately programmed general purpose computer. The Heck '698 Patent is hereby incorporated herein by reference in its entirety. Unless set forth otherwise, the nomenclature utilized herein is consistent with that of the Heck '698 Patent.

In one embodiment, the Heck '698 Patent disclosed and described the substitution of one explosive material for another and/or mixing multiple explosives to achieve the proper balance of rock mass and explosive energy to achieve consistent blasting results.

FIG. 1 provides a perspective view of the rock face and indicates various bench characteristics and drill pattern characteristics that are relevant. For example, FIG. 1 indicates bench characteristics such as bench height (also known as “face height”) 10, floor or final grade 12, toe 14, the crest 16, and bank angle 18, and drill pattern characteristics such as borehole diameter 20, hole depth 22, explosive column height 24, stem height 26, subgrade or subdrilling 28, spacing (“S”) 30 from one hole to the next on a drill line, back break 32, side break 34, burden (“B,” “hole-to-rock face burden or “front burden”) 36, bottom hole burden 38, burden (drill line-to-drill line burden) 40, drill line 42, start point 44 and end point 46. Material Factors and Energy Factors are also drill pattern characteristics. It will be noted that the term “burden” is used in the art in several senses. To avoid confusion, the term “hole-to-rock face burden” (B-a distance) shall refer to the distance from the bore-hole to the crest of the rock face and the term “rock burden” (B_{T}-a volume) shall indicate the amount of material to be blasted by a given hole. Other senses of the term “burden” will be apparent from the context of use.

The Heck '698 Patent set forth methods for determining the optimum positions for boreholes along a selected drill line to achieve proper fragmentation. With reference to FIG. 2 (which represents a portion of a bench to be blasted using boreholes and having a desired drill line from start point A to end point B), this was directed to a bench having cross sections (such as cross sections Ca-1, Ca-2, etc.); layers (such as layers (La-1, La-2, etc.); and boreholes (such as 66a, 66a′, etc.).

In recent years, the use of liquid explosive solutions with variable densities in the mining and construction industries has increased. Liquid explosives are of the emulsion or slurry types with the addition of non-explosive non-energetic components to vary the density of the product to control the amount of available energy per unit volume. Often, the addition of agents that produce small gas bubbles in the liquid explosive matrix are used for this purpose (although other methods can be used).

Although the use of these products is becoming widespread, no effective method for determining the proper density to be loaded in each section of the rock mass is available. Indeed, it is common to over add in the amount of agents (which decreases their density) resulting in inefficiencies both in their use and the associated costs.

According the need remains for an improved process to determine the proper selection and densities to be utilized for liquid explosive solutions.

### SUMMARY

In general, in one embodiment, the invention features a method that includes the step of selecting a single explosive material whose specific volume energy can be controlled for use. The method further includes determining a first target specific volume energy required for the single explosive material in a first segment of a borehole. The method further includes selecting a first product density of the single explosive material that will produce the first target specific volume energy.

Implementations of the invention can include one or more of the following features:

The method can further include the step of controlling the specific volume energy of the single explosive material to the first selected product density at the conditions of the first segment. The method can further include the step of loading the single explosive material having the first selected product density into the first segment of the borehole. The method can further include the step of detonating the single explosive material having the first selected product density.

The step of controlling the specific volume energy of the single explosive material to the first selected product density at the conditions of the first segment can include determining the density of the single explosive material at surface conditions that will yield the first selected product density at the conditions of the first segment.

The single explosive material can include a slurry or emulsion.

The specific volume energy of the single explosive material can be controlled by the injection of an agent into the single explosive material.

The agent can be a gas.

The injection of gas can include the formation of small bubbles in a matrix of the single explosive material.

The method can further include the step of determining a second target specific volume energy required for the explosive material in a second segment of the borehole. The method can further include the step of selecting a second product density of the single explosive material that will produce the second target specific volume energy.

The method can further include the step of controlling the specific volume energy of the single explosive material to the first selected product density at the conditions of the first segment. The method can further include the step of loading the single explosive material having the first selected product density into the first segment of the borehole. The method can further include the step of controlling the specific volume energy of the single explosive material to the second selected product density at the conditions of the second segment. The method can further include the step of loading the single explosive material having the second selected product density into the second segment of the borehole. The method can further include the step of detonating the single explosive material having the first selected product density and the single explosive material having the second selected product density.

The step of controlling the specific volume energy of the single explosive material to the first selected product density at the conditions of the first segment can include determining the density of the single explosive material at surface conditions that will yield the first selected product density at the conditions of the first segment. The step of controlling the specific volume energy of the single explosive material to the second selected product density at the conditions of the second segment can include determining the density of the single explosive material at surface conditions that will yield the second selected product density at the conditions of the second segment.

The step of determining a first target specific volume energy required for the single explosive material in a first segment of a borehole can include referring to stored data that indicates specific volume energies for the single explosive material.

The method can further include partitioning the borehole into a plurality of segments and determining the rock burden and target specific volume energy for the segments in the plurality of segments and separately identifying a target specific volume energy for each segment. One of the segments in the plurality of segments can be the first segment.

The method can further include determining the rock burden for the borehole and determining the Energy Factor and the size of the borehole to determine the first target specific volume energy required for the single explosive material in a first segment of a borehole.

In general, in another embodiment, the invention features a method that includes the step of selecting an explosive material and a non-explosive energetic material that can be controllably mixed. The method further includes the step of determining a first target specific volume energy required for a first segment of a borehole, The method further includes the step of determining a first product mixture comprising the explosive material and the non-explosive energetic material that will produce the first target specific volume energy.

Implementations of the invention can include one or more of the following features:

The method can further include the step of mixing the explosive material and the non-explosive energetic material to form the first product mixture. The method can further include the step of loading the first product mixture in the first segment of the borehole. The method can further include the step of detonating the first product mixture.

The non-explosive energetic material can be oil shale, coal, styrofoam, or a combination thereof.

The method can further include the step of determining a second target specific volume energy required for a second segment of the borehole. The method can further the step of include determining a second product mixture comprising the explosive material and the non-explosive energetic material that will produce the second target specific volume energy.

The method can further include the step of mixing the explosive material and the non-explosive energetic material to form the first product mixture. The method can further include the step of loading the first product mixture in the first segment of the borehole. The method can further include the step of mixing the explosive material and the non-explosive energetic material to form the second product mixture. The method can further include the step of loading the second product mixture in the second segment of the borehole. The method can further include the step of detonating the first product mixture and the second product mixture.

The step of determining a first target specific volume energy required in a first segment of a borehole can include referring to stored data that indicates specific volume energies for the single explosive material.

The method can further include partitioning the borehole into a plurality of segments and determining the rock burden and target specific volume energy for the segments in the plurality of segments and separately identifying a target specific volume energy for each segment. One of the segments in the plurality of segments can be the first segment.

The can further include determining the rock burden for the borehole and determining the Energy Factor and the size of the borehole to determine the first target specific volume energy required for a first segment of a borehole.

The explosive material can be a single explosive material whose specific volume energy can be controlled for use.

The single explosive material can be a slurry or emulsion.

The specific volume energy of the single explosive material can be controlled by the injection of an agent or agents into the single explosive material.

The agent can be a gas.

In general, in another embodiment, the invention features a computer readable media. The computer readable media can have computer readable instructions therein for performing one of the above described methods.

The foregoing has outlined rather broadly the features and technical advantages of various embodiments in order that the Detailed Description that follows may be better understood. Additional features and advantages will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

It is also to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

For a detailed description of example embodiments, reference will now be made to the accompanying drawings in which:

FIG. 1 is a perspective view of a bench to be blasted, showing various characteristics of the bench and the boreholes therein. FIG. 1 is FIG. 1 in the Heck '698 Patent.

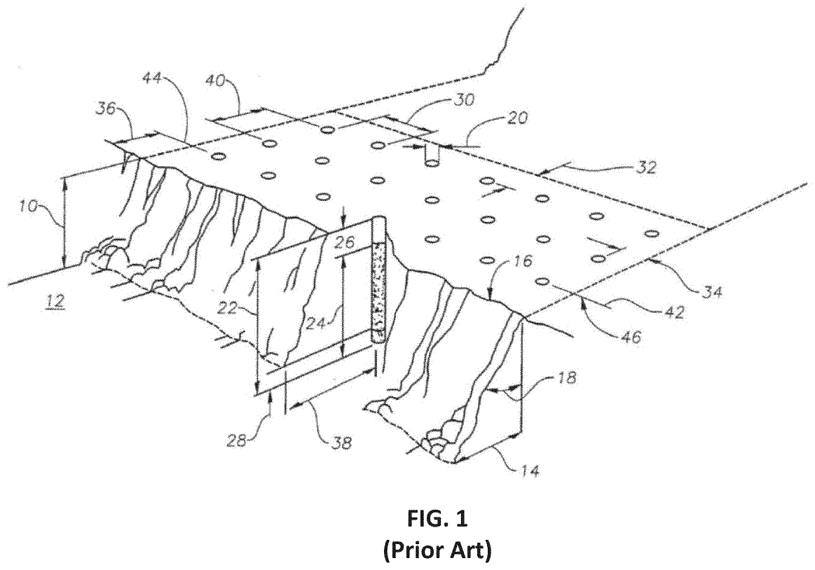

FIG. 2 is a partly cross-sectional, perspective volumetric view of a bench to be blasted using boreholes placed in accordance with the Heck '698 Patent. FIG. 2 is FIG. 3B in the Heck '698 Patent.

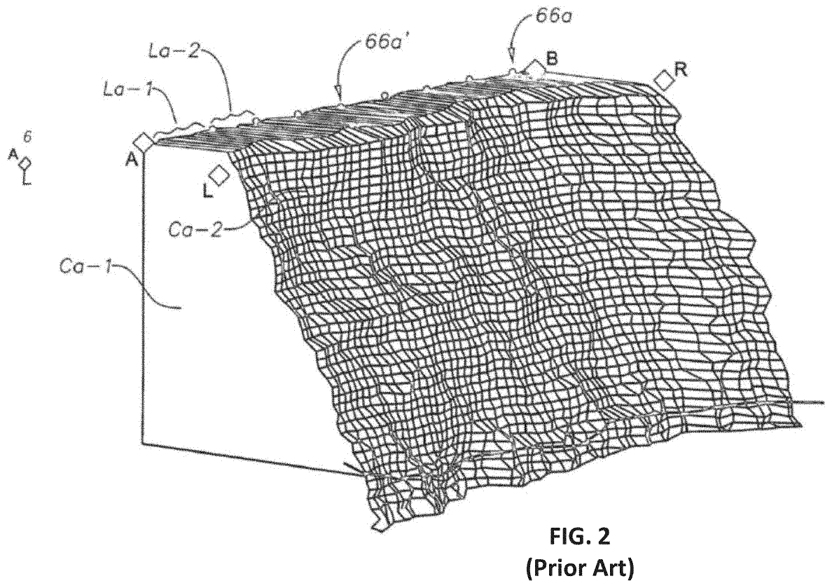

FIG. 3 is side view of a representative borehole in accordance with embodiments of the invention.

FIG. 4 is a graph showing the specific energy v. product density of different variable density explosives in accordance with embodiments of the invention.

FIG. 5 is a graph showing the relation between energy per unit volume (i.e., specific volume energy) and % oil shale for mixtures of ANFO and oil shale in accordance with embodiments of the invention.

FIG. 6 is a graph that reflects the distribution in the size of the resulting muck that results from differences in bench blasting methods in accordance with embodiments of the invention.

FIG. 7 illustrates a borehole loaded with a single explosive of variable density at a pre-determined profile of densities in accordance with embodiments of the invention.

FIG. 8 illustrates a borehole loaded with a mixture of explosive and non-explosive energetic materials at a pre-determined profile of densities in accordance with embodiments of the present invention.

### NOTATION AND NOMENCLATURE

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

As used herein, the term “about,” when referring to a value or to an amount of mass, weight, time, volume, concentration or percentage is meant to encompass variations of in some embodiments±20%, in some embodiments±10%, in some embodiments±5%, in some embodiments ±1%, in some embodiments ±0.5%, and in some embodiments±0.1% from the specified amount, as such variations are appropriate to perform the disclosed method.

As used herein, the term “and/or” when used in the context of a listing of entities, refers to the entities being present singly or in combination. Thus, for example, the phrase “A, B, C, and/or D” includes A, B, C, and D individually, but also includes any and all combinations and sub-combinations of A, B, C, and D.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

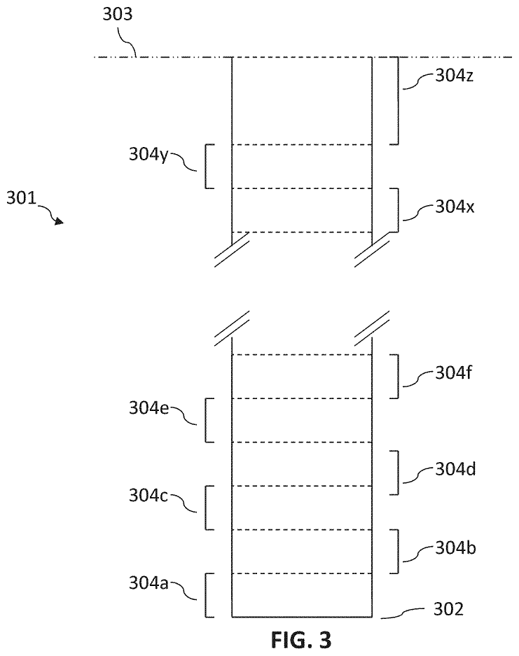

Various embodiments are directed to an improved blasting method. A side elevation, cross-sectional view of a representative borehole used for such blasting methods is shown in FIG. 3. The borehole 301 has a bottom 302 and a top 303 (at surface 303) in which the explosive materials can be deposited. The borehole 301 can be divided into pre-determined segments (such as on a per foot basis), i.e., from the bottom segments 304a-304f going to the top and ending at 304x-304z.

Typically, the top portion (segment 304z) is packed with a non-explosive (and inert) material to reduce/dampen the explosive forces that are created from propagating in that direction.

While the pre-determined segments, such as 304a-304f, are shown as being the same length, this does not have to necessarily be the case. However, other than segment 304z (which again is the top segment containing the inert materials), the pre-determined segments (304a-304f through 304x-304y) may be the same length. Typically, segment 304z is much greater in length.

The volume of the segment is determined by the cross-sectional area of the borehole 301 times the length of the pre-determined segment. If the segments are the same in length, they would then, accordingly, have the same volume. Various embodiments are utilized to provide the proper explosives to place into each of these segments along each of the multiple boreholes utilized in the blasting method.

### Embodiments With Single Explosive of Variable Density

Example embodiments are directed to a method for using a single explosive material whose specific volume energy can be controlled for use in at least a segment of a borehole, the method comprising determining a target specific volume energy required for an explosive material in a segment of the borehole and selecting a product density for that segment of the borehole which will produce the required target energy.

The density of the single explosive material is changed by the addition of non-explosive materials. Examples of single-explosive materials include emulsions or slurry types like the Orica Centra™ emulsion explosive (Orica USA, Inc., Watkins, Colo.), the Dyno Titan™ emulsion explosive (Dyno Nobel Inc., Salt Lake City, Utah), and Austin Powder Hydromite® emulsion explosive (Austin Powder Company, Cleveland, Ohio). Such emulsions or slurry types are varied in density by adding agents that produce small bubbles in the liquids explosive matrix (although other materials can be used).

It should be noted that some emulsions and slurry types are basically unable to explode without a sensitizing agent or agents being added into the liquid explosive matrix. The requirement for on-site sensitization to make the emulsion or slurry explosive function renders them much safer for transportation to the blasting site than many other forms of explosives. In addition to the sensitizing agent, or in conjunction with it, other agents can be added to create tiny gas bubbles in the explosive matrix, thus reducing the explosive material's density without significantly affecting its energy per unit weight.

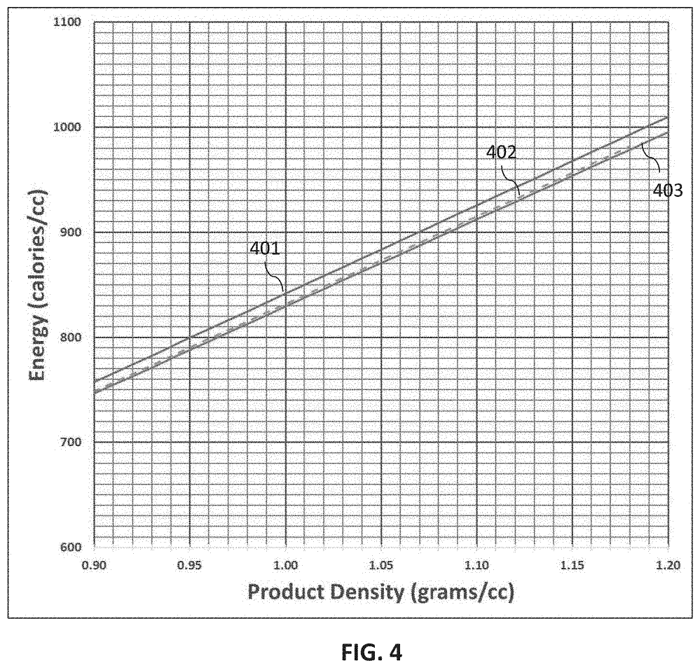

FIG. 4 is a plot of specific energy v. product density for different variable density explosives with lines 401-403 for (1) Orica Centra™ emulsion explosive, (2) Dyno Titan™ emulsion explosive and (3) Austin Powder Hydromite® explosive, respectively. As more small bubbles of gas are added to the liquid explosive matrix, the density of the liquid explosive mixture decreases, which renders the liquid explosive mixture to have a lower energy per unit volume.

One problem that arises in the prior art is that the industry is typically using fixed amounts of gas bubbled into the liquid explosive matrix, creating a uniform mixture profile in each borehole.

### EXAMPLE 1

Example 1 illustrates problems that arise by simply adding the agent to the liquid explosive matrix without any consideration as to the impact on the energy of the explosive. In a one-foot interval of three different boreholes having 3.5 in, 4.5 in, and 5.5 in diameters, respectively, a one-foot segment has volumes of 115.5 in³ (1,891.9 cc), 190.8 in³ (3127.5 cc), and 285.1 in³ (4671.9 cc), respectively. Per line 401 of FIG. 4, Orica Centra™ emulsion explosive with density of 0.9 grams per cubic centimeter (g/cc) (i.e., a large amount of gas has been bubbled into the matrix) has an energy of 757 calories per cubic centimeter (cal/cc). One-foot segments in the three boreholes filled with Orica Centra™ emulsion explosive of 0.9 g/cc density would have an output energy provided by the explosive material to be 1432.2 kcals, 2367.5 kcal, and 3536.6 kcal, respectively. If the desired Energy Factor was about 2956 kcal for that segment (see Example 2 below), this would necessitate using a 5.5 in diameter borehole with Orica Centra™ emulsion explosive with density of 0.9 g/cc (and would have excess output energy than required).

Moreover, because the prior art loads from the surface the slurry or emulsion explosive composition with the same density from borehole to borehole, the commonality of density leads to even more inefficiencies. Example embodiments herein permit tailoring of composition by adjusting the density within each segment, which provides for the proper amount of explosive forces in each segment.

### EXAMPLE 2

Example 2 illustrates how the procedures of various embodiments can be used to attain a desired Energy Factor through the loaded length of a blast hole through the use of a single explosive of variable density (for example an emulsion or slurry explosive whose density is modified by physical or chemical means), given a desired Material Factor (sometimes hereafter “MF”) based on ammonium nitrate/fuel oil (hereafter just “ANFO”). In the example embodiment, the following criteria are utilized:

Rock Density=2.23 tons per yd3=0.0826 tons per ft3

Target Material Factor MF=2.5 tons rock per pound ANFO (per 553.66 cc ANFO)

Hole-to-rock face burden=14 ft

Hole Spacing S=16 ft

Borehole Diameter d=4.5 inches=0.375 ft=11.43 cm

Borehole Segment L=1 ft=30.48 cm Under the example conditions, the rock burden associated with the one-foot length L of the borehole is calculated as (1 ft)×(14 ft)×(16 ft)×(0.0826 tons/ft3)=18.5 tons.

The ANFO required for this one-foot segment of borehole is calculated as (18.5 tons rock)/(2.5 tons rock/lbs. ANFO)=7.4 lbs. ANFO

The volume of explosive material in the one-foot length of borehole is 0.1104 ft³=3127.5 cc. To identify the suitable material, an amount of energy to be used in the particular segment is determined.

As calculated above, the target MF would use 7.4 lbs. of ANFO which, given the specific energy of ANFO of 880 cal/g, (399,520 cal/lb.), would provide (7.4 lbs.)×(399,520 cal/lb.)=2,956,448 cal. This is the output energy of the explosive material in the one-foot segment of the borehole (3127.5 cc) to attain an Energy Factor that would result from the desired Material Factor of 2.5. For the material in the one-foot segment of the borehole, this corresponds to a specific volume energy of 945.3 cal/cc.

Having determined the specific volume energy to be used, a suitable explosive material can be chosen. Referring to lines 401-403 of FIG. 4, the selected borehole segment would be loaded to a density of 1.122 g/cc for the Orica Centra™ emulsion explosive, 1.138 g/cc for the Dyno Titan™ emulsion explosive, or 1.140 g/cc for the Austin Powder Hydromite® explosive, respectively.

Each segment of the borehole can be analyzed in this way so that the explosive material loaded therein provides a uniform Energy Factor throughout the rock face to accommodate for variations in burden along the length of the borehole. Calculating and using a uniform Energy Factor throughout the rock mass produces consistent rock breakage throughout a homogeneous rock formation. Tailoring each segment to attain a desired Energy Factor for each segment in each borehole has significant ramifications on the efficiencies and costs of the process to make the muck. One example goal in the process is the distribution of the size of the muck resulting from the bench blasting method utilized.

It should be noted that the density of the single explosive of variable density, such as the Orica Centra™ emulsion explosive, the Dyno Titan™ emulsion explosive, and the Austin Powder Hydromite® explosive, at surface pressure is not the same as at the pressure when placed in the segment of the borehole. This is due to the hydrostatic head of the borehole segments that are above. A person of ordinary skill would understand how to calculate the surface density of the single explosive of variable density so that it would be at the pre-determined density when positioned in the relevant segment.

Embodiments Using A Mixture Of Explosive and Non-Explosive Energetic Materials

Other example embodiments are directed to a method for using mixtures of one or more explosive materials and one or more non-explosive energetic materials whose specific volume energy can be controlled for use in at least one segment of a borehole. The method includes determining a target specific volume energy for an explosive material in a segment of the borehole and selecting a product mixture for that segment of the borehole which will produce the required target energy. In one example embodiment the non-explosive can be hydrocarbon based (coal, oil shale, etc.), but other materials can be used.

### EXAMPLE 3

Example 3 illustrates how the procedures of the various embodiments can be used to attain a desired Energy Factor through the loaded length of a blast hole by using mixtures of one or more explosive materials and one or more non-explosive energetic materials, given a desired Material Factor based on ANFO. Examples of explosive materials are ANFO, emulsion or slurry explosives and mixtures of the two. Examples of non-explosive energetic materials are oil shale, coal, and styrofoam. Other explosive and non-explosive energetic materials can be alternatively used. In this Example 3, mixtures of ANFO and OS5™ oil shale (a product of ANA, LLC (Canton, Ga.) with a known energy content will be used based under the following criteria:

Rock Density=2.23 tons per yd3=0.0826 tons per ft3

Target Material Factor MF=2.5 tons rock per pound ANFO (per 553.66 cc ANFO)

Hole-to-rock face burden=14 ft.

Hole Spacing S=16 ft.

Borehole Diameter d=4.5 inches=0.375 ft=11.43 cm

Borehole Segment L=1 ft.=30.48 cm

Under these conditions, the rock burden associated with the one-foot length L of the borehole is calculated as (1 ft)×(14 ft)×(16 ft)×(0.0826 tons/ft³)=18.5 tons. The ANFO used for this example one-foot segment of borehole is calculated as (18.5 tons rock)/(2.5 tons rock/lbs. ANFO)=7.4 lbs. ANFO. The volume of explosive material in the example one-foot segment of borehole is 0.1104 ft3=3127.5 cc. To identify the requisite material, a calculation is made to determine the amount of energy to be used by the explosive material in that segment of the borehole.

As calculated above, the target MF would use 7.4 lbs. ANFO which, given the specific energy of ANFO of 880 cal/g, (399,520 cal/lb.), would provide (7.4 lbs.)×(399,520 cal/lb.)=2,956,448 cal. This is the output energy provided by the explosive material in the one-foot segment of the borehole (3127.5 cc) to attain an Energy Factor that would result from the desired Material Factor of 2.5. For the material in the one-foot segment of the borehole, this corresponds to a specific volume energy of 945.3 cal/cc.

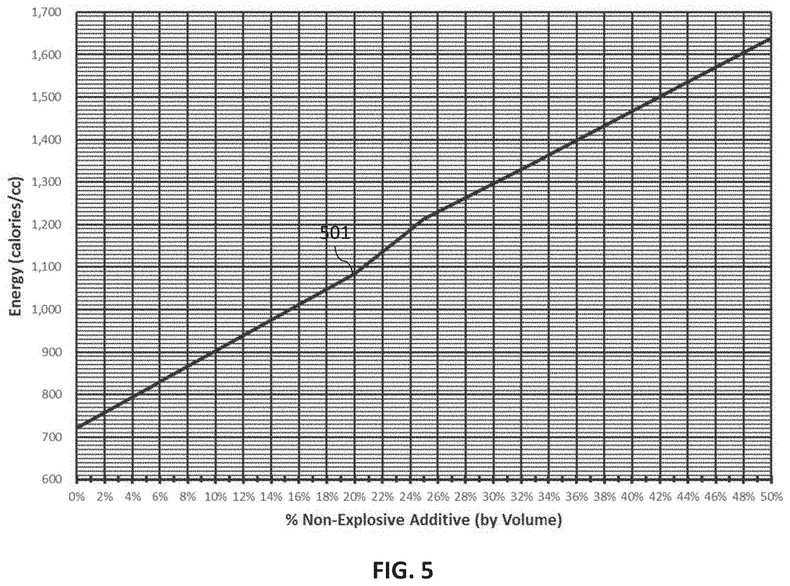

Having determined the specific volume energy for the segment, a suitable explosive/non-explosive mixture can be chosen. FIG. 5 is a graph showing in curve 501 the relation between energy per unit volume (i.e., specific volume energy) and % oil shale for mixtures of ANFO and OS5™ oil shale. Such data can be provided in digital form for use when the foregoing procedure is utilized using a computer.

In this Example 3, the selected borehole segment would be loaded with a mixture of ˜12.5% oil shale and ˜87.5% ANFO.

Similar to the embodiments discussed above using a single explosive of variable density, each segment of the borehole can be analyzed in this way so that the explosive material loaded therein provides a uniform Energy Factor throughout the rock face to accommodate for variations in burden along the length of the borehole. This even and consistent energy distribution throughout the rock mass also produces consistent rock breakage throughout a homogeneous rock formation

Utilizing the non-explosive energetic materials provides further control of the blasting process. Moreover, there are significant cost advantages to the example embodiments, as the non-explosive energetic materials are less expensive per amount of energy released. Also, since the energy being released by the non-explosive energetic materials is also greater per volume, fewer holes can be drilled per unit mass of rock or smaller diameter boreholes can be utilized (which again provides for efficiencies and costs savings in the blasting process).

Single Explosive of Variable Density Mixed With Non-Explosive Energetic Materials

Example embodiments further include a combination of the single explosive of variable density with non-explosive energetic materials. For example, a slurry or emulsion can be added with the gas bubbles and non-explosive energetic materials, such as oil shale, coal, and styrofoam.

Determination Procedure

Example embodiments include a procedure for improving upon the evaluation of drill pattern parameters such as burden, spacing, borehole diameter, etc., at a blast site as set forth in the Heck '698 Patent. Example embodiments can utilize a process similar to that set forth in FIGS. 9A-9B in Heck '698 Patent (which illustrate for identifying a cost-directed spacing for at least one borehole on a drill line). Various embodiments improve upon step 112 of the Heck '698 Patent (shown in FIG. 9A of the Heck '698 Patent) by further control and evaluation of the selection of the explosive materials that are utilized. By this added control, the pertinent characteristics of explosive materials, including cost, density, and specific energy can be considered and utilized in the design.

Rock Breakage Quality

As noted above, consistent energy distribution throughout the rock mass produces consistent rock breakage throughout a homogeneous rock formation. Hence, not only are there efficiencies and cost benefits associated with the example blasting method itself, the improvement of the quality of the rock breakage further provides efficiencies and cost benefits downstream with respect to the processing of the resulting rock materials.

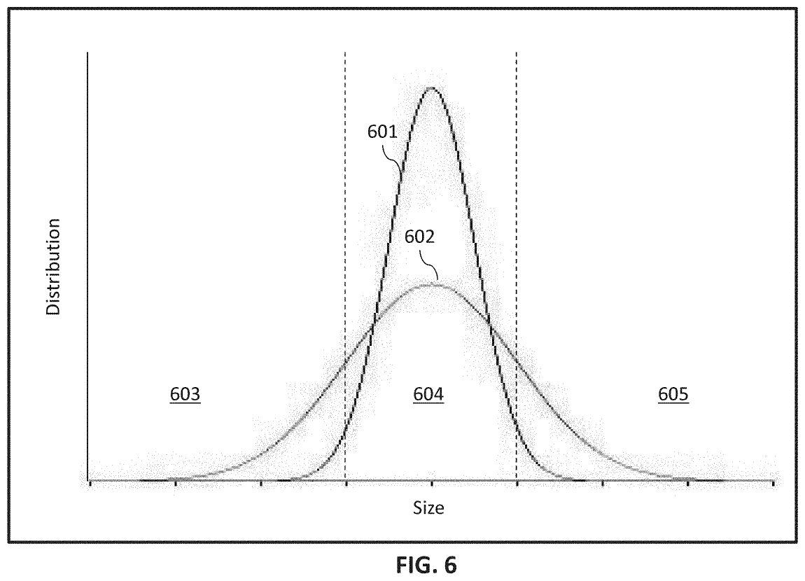

FIG. 6 is a graph that reflects the distribution in the size of the rock breakage that results from differences in bench blasting methods. Curves 601 and 602 show relative distributions between two different bench blasting methods, with curve 601 having a tighter distribution profile.

Region 603 reflects sizes in which the resulting rock breakage is too small and may have little or no value. Such rock material in that distribution cannot be profitably sold. This material in region 603 is basically waste material that must be removed.

Region 605 reflects sizes in which the rock breakage resulted in rock materials that are oversized, and further processing must take place in order to further reduce the size of the oversized rock. Such additional processing steps (to reduce the oversized rocks in region 605) is quite expensive and raises the overall costs of production substantially. The additional processing of oversized rocks includes treating these oversized rocks with different equipment (hydraulic rock breakers, for example) to reduce their size before they can be processed with the rocks that come from region 604. Moreover, if an oversized rock is processed in the standard processing equipment (used for the rocks of sizes from region 604), the oversized rock could cause delays due to getting stuck or damaging the standard size rock processing equipment. Often these oversize rocks become waste material, reducing profits and creating additional handling issues.

Accordingly, reducing or minimizing the distribution of rock materials in both region 603 and 605 reaps rewards, as this both increases yield and decreases subsequent processing costs. Moreover, a tighter distribution of the rock sizes within region 604 also yields better rocks that are easier to process in the standard size rock processing equipment. Thus, the efficiencies and costs are not simply in the costs for the bench blasting itself, but also for the yield and costs associated with the rocks that result from the bench blasting method.

Again, in the example embodiments each part of the borehole (e.g., each segment) can be analyzed so that the explosive material loaded therein provides a uniform Energy Factor throughout the rock face to accommodate for variations in burden along the length of the borehole. The various embodiments provide energy distribution throughout the rock mass, which produces more consistent rock breakage throughout the rock formation (i.e., by controlling the blasting method of a segment by segment level within each borehole, the size distribution of the resulting rocks is tightened so that there is greater yield with better size uniformity in region 604).

Loading Of The Borehole With The Pre-Determined Profiles

Embodiments of the present invention include determining the borehole pre-determined profiles. Further embodiments the process by which the boreholes are prepared, including the loading of the materials in the boreholes for the bench blasting method.

Embodiments of the present invention can be performed by pre-determining the profile of the boreholes and then loading the boreholes. For example, each borehole can be loaded one at a time, from bottom to top, before loading the next borehole in the sequence.

### EXAMPLE 4

Example 4 illustrates how the profiles are determined (and then loaded) utilizing (a) a single explosive of variable density and (b) a mixture of an explosive material with a non-explosive energetic material. Referring to the borehole 301 of FIG. 3, in this Example 4, the energies have been calculated (calories per cc) for the segments 304a-304f and 304x-304y (according to the example embodiments) as shown in TABLE 1 (with segment 403z to be packed with the inert material).

TABLE 1

| | Energy |
|---|---|
| Segment | cal/cc |
| 304z | 0 |
| 304y | 800 |
| 304x | 810 |
| 304f | 890 |
| 304e | 900 |
| 304d | 920 |
| 304c | 934 |
| 304b | 940 |
| 304a | 960 |

TABLE 2 reflects the corresponding densities for the Orica Centra™ emulsion explosive determined from line 401 of FIG. 4 and the % oil shale for mixtures of ANFO and OS5™ oil shale determined from curve 501 of FIG. 5.

TABLE 2

| | Energy | Density of | % OS5 ™ Oil Shale |
|---|---|---|---|
| Segment | (cal/cc) | Orica Centra ™ | in ANFO/Oil Shale |
| 304z | 0 | N/A | N/A |
| 304y | 800 | 0.94 | 4.6% |
| 304x | 810 | 0.96 | 5.0% |
| 304f | 890 | 1.05 | 9.6% |
| 304e | 900 | 1.06 | 9.8% |
| 304d | 920 | 1.08 | 11.0% |
| 304c | 934 | 1.10 | 11.8% |
| 304b | 940 | 1.11 | 12.2% |
| 304a | 960 | 1.13 | 13.2% |

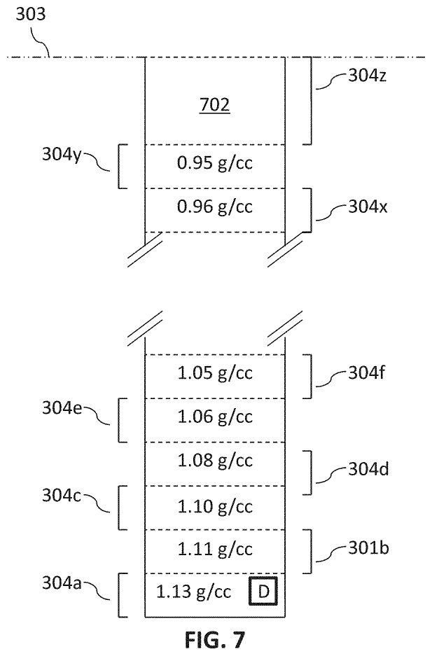

FIG. 7 illustrates borehole 301 loaded with the Orica Centra™ emulsion explosive at the profile of densities set forth in TABLE 2.

As shown in FIG. 7, a detonator 701 is positioned near the bottom of the borehole 301. Typically, this can be done before any loading of the explosive material into the borehole. The detonators' properties are selected so that they can then be detonated in a prearranged sequence (within and between boreholes).

Borehole 301 is then loaded at the pre-determined densities into each segment. As noted above, the density of the single explosive of variable density at the surface is not the same as what it will be when positioned into each segment.

For example, the profile is for the Orica Centra™ emulsion explosive at a downhole borehole density of 1.13 g/cc to be loaded into segment 304a. When the segment is one-foot in length and the diameter of the borehole is 4.5 inches, the volume of explosive material in the segment 304a of borehole is 0.1104 ft³ (which is 3127.5 cc).

A person of ordinary skill in the art would be able to readily determine the hydrostatic head on top of segment 304a based upon the profile of the borehole. This would yield the pressure for the Orica Centra™ emulsion explosive to be positioned in segment 304a. Since the Orica Centra™ emulsion explosive (as well as other single explosives of variable density) are generally compressible fluids, the amount of compression due to this pressure at segment 304a must be taken into account, when determining the surface density and volume to be pumped down the borehole.

For instance, assume the Orica Centra™ emulsion explosive having a density of 1.085 g/cc would compress by 4% at the pressure in segment 304a (i.e., the volume of such Orica Centra™ emulsion explosive in segment 304a would be 96% of its volume at the surface). This change in volume yields a density of 1.085 g/cc divided by 0.96 in segment 304a, which equals a density of 1.13 g/cc in segment 304a (i.e., the pre-determined density for the profile as shown in TABLE 3. Moreover, to fill a volume of 3127.5 cc in segment 304a, this would be a volume at the surface of 3257.8 cc times 96%, which equals a volume of 3,127.5 cc in segment 304a (i.e., the volume of segment 304a).

Accordingly, under these conditions, to yield the pre-determined profile of 1.13 g/cc in segment 304a, this calculates to pumping 3257.8 cc of Orica Centra™ emulsion explosive at 1.085 g/cc at surface conditions. The adding of the agent can then be done at the surface to provide this density.

In a similar manner, the respective surface densities and volumes to be pumped into each of the segments 304b-304f and 304x-304y are determined, such that the in-borehole materials are at the densities as shown in FIG. 7. Non-explosive (and inert) material 702 is packed in segment 304z to reduce/dampen the explosive forces that are created from propagating in that direction.

While not shown in FIG. 7, optionally, the detonator can be placed at other locations in the hole or one or more additional detonators can be placed down the borehole as desired.

Such process can then be repeated for each additional borehole (utilizing the profile of densities for each respective borehole).

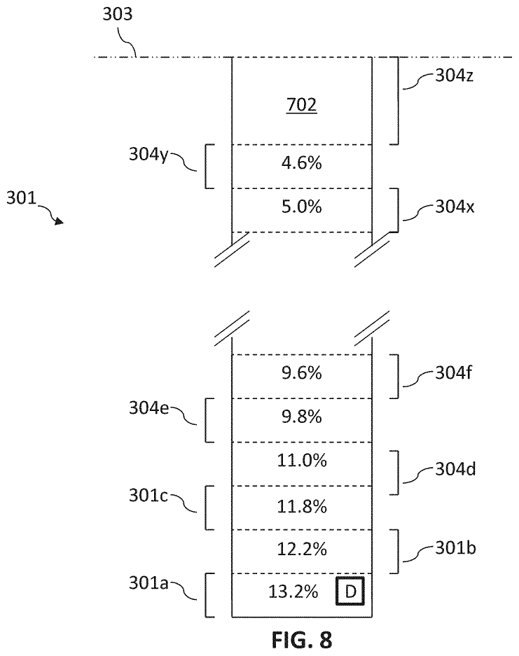

FIG. 8 illustrates borehole 301 loaded with the pre-determined profile of the % oil shale for mixtures of ANFO and OS5™ oil shale as set forth in TABLE 2. These dry components can be mixed at the surface (such as with augers) to obtain the desired mixtures. Alternately, mixtures of liquid and solid materials can be utilized as well.

As the example ANFO and oil shale are dry components, the dry components can be positioned downhole by readily depositing them from bottom to top. As the percentages of oil shale for mixtures of ANFO and oil shale reduce from bottom to top of the borehole, the amount of oil shale per ANFO is decreased as the segments 304a-304f and 304x-304y are filled.

While various embodiments of the invention have been shown and described, modifications thereof can be made by one skilled in the art without departing from the spirit and teachings of the invention. The embodiments described, and the examples provided herein are exemplary only, and are not intended to be limiting. Many variations and modifications of the invention disclosed herein are possible and are within the scope of the invention. Accordingly, other embodiments are within the scope of the following claims. The scope of protection is not limited by the description set out above.

The disclosures of all patents, patent applications, and publications cited herein are hereby incorporated herein by reference in their entirety, to the extent that they provide exemplary, procedural, or other details supplementary to those set forth herein.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method comprising the steps of:
(a) selecting a single explosive material whose specific volume energy can be controlled for use;
(b) determining a first target specific volume energy required for the single explosive material in a first segment of a borehole; and
(c) selecting a first product density of the single explosive material that will produce the first target specific volume energy.

2. The method of claim 1 further comprising the steps of:
(a) controlling the specific volume energy of the single explosive material to the first selected product density at the conditions of the first segment;
(b) loading the single explosive material having the first selected product density into the first segment of the borehole; and
(c) detonating the single explosive material having the first selected product density.

3. The method of claim 2, wherein the step of controlling the specific volume energy of the single explosive material to the first selected product density at the conditions of the first segment comprises determining the density of the single explosive material at surface conditions that will yield the first selected product density at the conditions of the first segment.

4. The method of claim 1, wherein the single explosive material comprises a slurry or emulsion.

5. The method of claim 1, wherein the specific volume energy of the single explosive material can be controlled by the injection of an agent into the single explosive material.

6. The method of claim 5, wherein the agent is a gas.

7. The method of claim 6, wherein the injection of gas comprises the formation of small bubbles in a matrix of the single explosive material.

8. The method of claim 1 further comprising the steps of:
(a) determining a second target specific volume energy required for the explosive material in a second segment of the borehole; and
(b) selecting a second product density of the single explosive material that will produce the second target specific volume energy.

9. The method of claim 8 further comprising the steps of:
(a) controlling the specific volume energy of the single explosive material to the first selected product density at the conditions of the first segment;
(b) loading the single explosive material having the first selected product density into the first segment of the borehole;
(c) controlling the specific volume energy of the single explosive material to the second selected product density at the conditions of the second segment;
(d) loading the single explosive material having the second selected product density into the second segment of the borehole; and
(e) detonating the single explosive material having the first selected product density and the single explosive material having the second selected product density.

10. The method of claim 9, wherein
(a) the step of controlling the specific volume energy of the single explosive material to the first selected product density at the conditions of the first segment comprises determining the density of the single explosive material at surface conditions that will yield the first selected product density at the conditions of the first segment; and
(b) the step of controlling the specific volume energy of the single explosive material to the second selected product density at the conditions of the second segment comprises determining the density of the single explosive material at surface conditions that will yield the second selected product density at the conditions of the second segment.

11. The method of claim 1, wherein the step of determining a first target specific volume energy required for the single explosive material in a first segment of a borehole comprises referring to stored data that indicates specific volume energies for the single explosive material.

12. The method of claim 1 further comprising partitioning the borehole into a plurality of segments and determining the rock burden and target specific volume energy for the segments in the plurality of segments and separately identifying a target specific volume energy for each segment, wherein one of the segments in the plurality of segments is the first segment.

13. The method of claim 1 further comprising determining the rock burden for the borehole and determining the Energy Factor and the size of the borehole to determine the first target specific volume energy required for the single explosive material in a first segment of a borehole.

14. A method comprising the steps of:
(a) selecting an explosive material and a non-explosive energetic material that can be controllably mixed;
(b) determining a first target specific volume energy required for a first segment of a borehole; and
(c) determining a first product mixture comprising the explosive material and the non-explosive energetic material that will produce the first target specific volume energy.

15. The method of claim 14 further comprising the steps of:
(a) mixing the explosive material and the non-explosive energetic material to form the first product mixture;
(b) loading the first product mixture in the first segment of the borehole; and
(c) detonating the first product mixture.

16. The method of claim 14, wherein the non-explosive energetic material is selected from the group consisting of oil shale, coal, styrofoam, and combinations thereof.

17. The method of claim 14 further comprising the steps of:
(a) determining a second target specific volume energy required for a second segment of the borehole; and
(b) determining a second product mixture comprising the explosive material and the non-explosive energetic material that will produce the second target specific volume energy.

18. The method of claim 17 further comprising the steps of
(a) mixing the explosive material and the non-explosive energetic material to form the first product mixture;
(b) loading the first product mixture in the first segment of the borehole;
(c) mixing the explosive material and the non-explosive energetic material to form the second product mixture;
(d) loading the second product mixture in the second segment of the borehole; and
(e) detonating the first product mixture and the second product mixture.

19. The method of claim 14, wherein the step of determining a first target specific volume energy required in a first segment of a borehole comprises referring to stored data that indicates specific volume energies for the single explosive material.

20. The method of claim 14 further comprising partitioning the borehole into a plurality of segments and determining the rock burden and target specific volume energy for the segments in the plurality of segments and separately identifying a target specific volume energy for each segment, wherein one of the segments in the plurality of segments is the first segment.

21. The method of claim 14 further comprising determining the rock burden for the borehole and determining the Energy Factor and the size of the borehole to determine the first target specific volume energy required for a first segment of a borehole.

22. The method of claim 14, wherein the explosive material is a single explosive material whose specific volume energy can be controlled for use.

23. The method of claim 22, wherein the single explosive material comprises a slurry or emulsion.

24. The method of claim 22, wherein the specific volume energy of the single explosive material can be controlled by the injection of an agent or agents into the single explosive material.

25. The method of claim 24, wherein the agent is a gas.

26. (canceled)
